(19) United States
(12) Patent Application Publication
(10) Pub. No.: US 2008/0179889 A1
(43) Pub. Date: Jul. 31, 2008

(54) VEHICLE BATTERY CHARGER AND METHOD OF OPERATING SAME

(76) Inventor: Taiken Matsui, Shizuoka-ken (JP)

Correspondence Address: Ernest A. Beutler, 10 Rue Marseille, NewPort Beach, CA, 92660-8016, US

(21) Appl. No.: 11/876,154

(22) Filed: Oct. 22, 2007

(30) Foreign Application Priority Data
Jan. 9, 2007 (JP) 2007-001190

(51) Int. Cl. H02P 9/02; H02J 7/14; F02N 11/04

(52) U.S. Cl. 290/36 R; 290/50; 320/128

(57) ABSTRACT

A charging device for an internal combustion engine and an associated battery for supplying electric power to a component driven by the engine. A generator is driven the engine to generate electric power to be supplied as charging current to the battery. A charge controller controls the value of the charging current supplied to the battery according to the operating state of the engine after a certain phase, of positive voltage waveform of the generated electric power and adjusts the phase in response to the speed of said internal combustion engine.

### BACKGROUND OF THE INVENTION

This invention relates to a battery charger driven by an engine, for example in a vehicle and a method for regulating the charging therefore.

As is well known, in many instances an internal combustion engine is employed as a method for producing power. For example internal combustion engines frequently power many types of vehicles such as motorcycles and the like. Of course the engine can not start itself and often electric starter motors are used for this purpose. Of course the starter motor must be powered and during cranking the engine driven generator can not provide sufficient power for this purpose. Therefore the vehicle is generally provided with a storage battery, not only for starting but also for powering various electrically operated accessories of the vehicle such as lights and the like.

Of course, it is desirable to control the battery charging so as to insure the availability of sufficient electrical power at all times and also to avoid overcharging and early failure of the battery.

Therefore, at the startup time, as an example of operating state, of the internal combustion engine, the generator is also driven with the engine in the startup state, so that the charging current produced as described above with the generator is supplied to the battery. That is that at the startup time of the internal combustion engine, the electric power from the battery is consumed, not only with the starter motor, but also with the generator driven with the internal combustion engine in the startup state. Therefore, the electric power supplied from the battery to drive the starter motor is prone to decrease as the generator also requires the electric power of the battery. Therefore, there is a risk that the internal combustion engine cannot be started up quickly.

Therefore, it has been proposed that at the startup time of the internal combustion engine by controlling with the charge controller, to reduce the charging current value outputted from the generator and supplied to the battery. This makes it possible to reduce the electric power of the battery required to drive indirectly the generator along with starting up the internal combustion engine. Accordingly, it becomes possible to supply enough electric power for the starter motor. As a result, the internal combustion engine may be started up quickly with the starter motor.

A typical charging condition controller is shown in Japanese Published Patent Application JP-A-2003-284256. However the details thereof do not make it clear to those skilled in the art how, if at all, charging under all conditions can be accurately and simply controlled.

It is, therefore, a principal object of this invention object of the invention is to provide an on-vehicle charger of a simple constitution that makes it possible to control the charging current value supplied from the generator to the battery according to the operating state of the internal combustion engine.

### SUMMARY OF THE INVENTION

This invention is adapted to be embodied in combination with a vehicle comprising an internal combustion engine for powered drive, a battery for supplying electric power to vehicle-mounted components such as the internal combustion engine, a generator driven with the internal combustion engine to generate electric power to be supplied as charging current to the battery. In accordance with the invention, a charge controller capable of controlling the value of the charging current according to the operating state of the internal combustion engine is employed. The charge controller controls to supply to the battery the charging current corresponding to part, after a certain phase, of positive voltage waveform of the generated electric power and to delay the phase according to decrease in the speed of the internal combustion engine.

Another feature of the invention relates to a method of controlling the charging of a battery for supplying electric power to vehicle-mounted components such as the internal combustion engine by a generator driven with the internal combustion engine to generate electric power to be supplied as charging current to the battery. In accordance with this feature of the invention, the amount of charging is controlled according to the operating state of the internal combustion engine. The charge supplied to the battery is a charging current corresponding to part, after a certain phase, of positive voltage waveform of the generated electric power and the phase shortened in response to a decrease in the speed of the internal combustion engine.

### BRIEF DESCRIPTION OF THE DRAWINGS

FIG. 1 is a schematic view of a vehicle powered by an internal combustion engine and having a battery charging system constructed and operated in accordance with the invention.

FIG. 2 is a diagrammatic view showing how the charging is controlled in accordance with the invention.

FIG. 3 is a graphical view showing how the amount of charging is related to engine speed.

### DETAILED DESCRIPTION

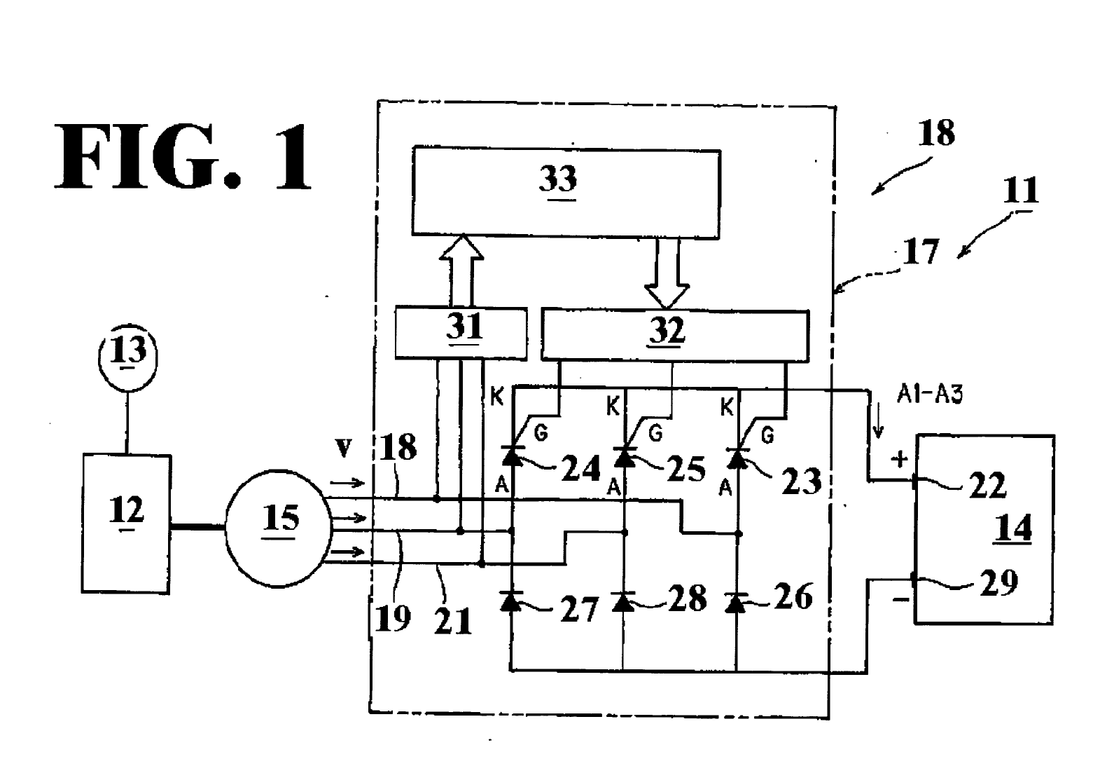

Referring first to FIG. 1, this shows very schematically at 11 a vehicle having a battery charged in accordance with the invention. The vehicle 11 may be of any known type, although the invention is particularly adapted for use in vehicles that are operated by a rider seated in straddle fashion, such as a motorcycle. The vehicle comprises as a power source an internal combustion engine 12 for powered drive of the vehicle in any known manner.

The engine 12 may, if desired, be started by a starter motor, shown schematically and indicated generally by the reference numeral 13. Although the vehicle engine may be kick started, the charging system to be described is particularly suited for electric motor started engines.

For powering the starter motor 13, there is provided a storage battery 14 that also supplies electric power to other vehicle-mounted components such as an ignition system for the internal combustion engine 12. The charge on the battery 14 is maintained by a three phase DC generator 15 driven suitably from the internal combustion engine 12 to generate electric power V to be supplied as charging current A to the battery 14. In accordance with the invention, a charge controller indicated generally at 16 and embodying the invention, controls the value of the charging current A according to the operating state of the internal combustion engine 12, as will be described shortly. This charging is controlled by a control device 17.

The control device 17 comprises the first to third phase output lines 18, 19 and 21 for connecting the generator 15 to the positive terminal 22 of the battery 14 through first to third switching elements 23, 24 and 25 shown for example as thyristors interposed in the middle of the phase output lines 18, 19 and 21, and through the first to third diodes 26, 27 and 28 for connecting the negative terminal 29 of the battery 14 to the anodes of the first to third thyristors 23, 24 and 25.

The charge controller 16 also comprises a phase detecting circuit 31 for detecting generated electric power V of the respective first to third phase output lines 18, 19 and 21 and their phase difference. Also a gate driving circuit 32 applies gate currents as phase control signals to the gates of the first to third thyristors 23, 24 and 25, respectively and for causing the charging current A to flow from their anodes to cathodes during the signal application.

In addition, a central control device 33 receives output signals such as the revolution, as one of operating state elements, of the internal combustion engine 12. Also the central control device 33 outputs signals from the phase detecting circuit 31 for driving the gate driving circuit 32 according to the operating state of the internal combustion engine 12. Thus the output signals from the phase detecting circuit 31 causing the gate driving circuit 32 to output the phase control signals.

As seen in FIG. 1, when the internal combustion engine 12 is operated, the generator 15 is driven with the driving force outputted from the internal combustion engine 12. Then, generated electric power V is outputted to the first to third phase output lines 18, 19 and 21 of the generator 15 sequentially at a phase difference of 120 degrees.

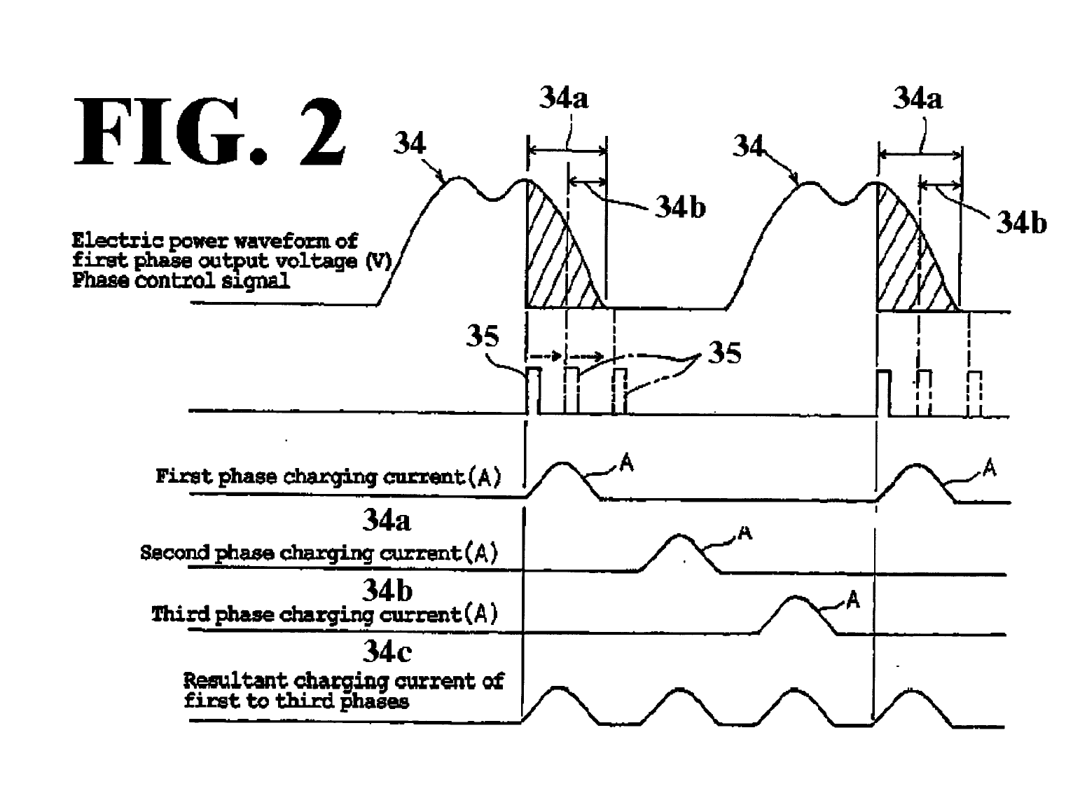

Referring now to FIG. 2, this shows the generated electric power V as a positive voltage waveform 34 on the first phase output line 18 as a representative of the generated electric power V of the first to third phase output lines through the diodes 26, 27 and 28. By the control of the charge controller 16, a phase control signal is outputted at a certain phase 35 of the voltage waveform 34 from the gate driving circuit 32 to the gate of the first switching element 23. Then, the first switching element 23 is turned on to supply a charging current A of the first phase corresponding to the waveform part 34a after the phase 35 to the battery 14. Also in the same manner as described above, charging currents A of the second and third phases are supplied according to the generated electric power V of the second and third phase output lines 24 and 25 to the positive terminal 22 of the battery 14 sequentially at a phase difference of 120 degrees.

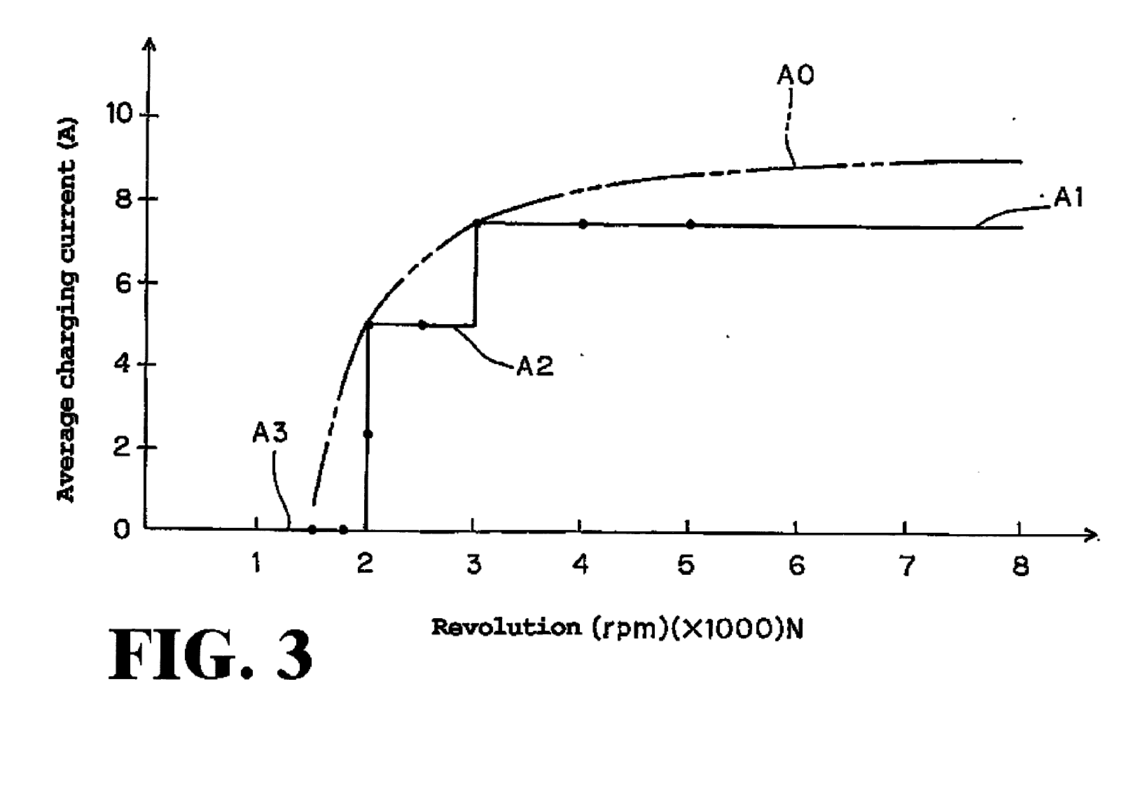

Referring now to FIG. 3, the phase 35 shown in FIG. 2 is assumed to be in a high speed state of N>3000 rpm as one of the operating states of the internal combustion engine 12. In this case, an average charging current A1 supplied to the battery 14 is made to be about 8 amperes (A).

If the revolution speed N of the internal combustion engine 12 decreases from the high speed state above to a medium speed state of 2000 rpm≦N≦3000 rpm, the phase 35 is delayed (phantom line in FIG. 2). Respective charging currents A of the first to third phases corresponding to the small waveform part 34b after the phase 35 are supplied to the battery 14. In this case and as shown in FIG. 3, the average charging current A2 supplied to the battery is reduced to be about 5 amperes (A).

When the revolution speed N of the internal combustion engine 12 further decreases from the medium speed state above to a low speed state of N<2000 rpm, the phase 35 is further delayed (phantom line in FIG. 2) to come to approximately the lowest part of the voltage waveform 34. As a practical matter, the phase 35 is outside the voltage waveform 34. As a result, respective charging currents A of the first to third phases become zero. The above-mentioned low speed state of the internal combustion engine 12 corresponds to its startup or idling state.

The phantom line in FIG. 3 indicates the value of average charging current A0, without the charge controller 16, with the voltage waveform 34 of each of generated electric power V on the first to third phase output lines 18, 19 and 21 directly converted to the charging current A as would apply through a conventional charger. When the internal combustion engine 12 is provided with the conventional charger, the average charging current A0 in the high revolution N range tends to be too great and produce useless heat losses in both the internal combustion engine 12 and the battery 14.

However, when the average charging current A1 is made smaller through the above charger 17 than the average charging current A0 through the conventional charger, the useless heat losses are prevented from occurring and so the output loss of the internal combustion engine 12 is reduced.

As another case as an example, if the internal combustion engine 12 is accelerated with the revolution N of the internal combustion engine 12 in the medium speed range, the average charging current A0 through the conventional charger is high. Thus the load on the internal combustion engine 12 for driving the generator 15 is great and acceleration is hindered.

However, with the average charging current A2 made smaller through the charger 17 than the average charging current AO through the conventional charger, the load on the internal combustion engine 12 for driving the generator 15 is held small. Therefore, the desired acceleration is obtained with the internal combustion engine 12.

Also there is the case in which the revolution speed N of the internal combustion engine 12 is in the low speed state. For example, this may be a case in which the internal combustion engine 12 is started up with the electric power of the battery 14. In this case, the average charging current A0 supplied from the generator 15 through the conventional charger to the battery 14 is great and the load on the battery 14 for driving the generator 15 rotating as interlocked with the internal combustion engine 12 is great. Therefore, it is difficult to start the internal combustion engine 12 quickly with only the electric power of the battery.

In this case, with the invention as described, power from the generator 15 to the battery 14, is reduced to the average charging current A3 and this is smaller than the average charging current A0 supplied from the generator 15 to the battery 14 through the conventional charger. As a result, the internal combustion engine 12 is started up quickly with the electric power of the battery 14.

Thus, in accordance with the structure and method described, the control by the charge controller 16 supplies a charging current A corresponding to part of waveform 34a, after the certain phase 35, of the positive voltage waveform 34 of the generated electric power V to the battery 14 and delays the phase 35 in response to a decrease in the speed N of the internal combustion engine 12.

Therefore, when the generator 15 is driven with the internal combustion engine 12, the average charging current A1-A3 supplied from the generator 15 to the battery 14 in each range of revolution N of the internal combustion engine 12 tends to be smaller than the average charging current A0 produced by a conventional charger. This is beneficial in preventing useless heat losses occurring in the internal combustion engine 12 and the battery 14, thereby reducing output loss of the internal combustion engine 12 and improving fuel economy.

The charge controller 16 and method of the described construction is capable of controlling and decreasing the average charging current A1-A3 supplied from the generator 15 driven by the internal combustion engine 12 to the battery 14 according to the operating state of the internal combustion engine 12, based on the so-called phase control (angular control). Therefore the charger 16 is simple in constitution and makes it possible to simplify the constitution of the on-vehicle charger.

Of course those skilled in the art will readily understand that the foregoing construction and operation is that of only one embodiment of the invention and is capable of change and modification without departing from the spirit and scope of the invention, as defined by the appended claims. By way of example only, the internal combustion engine 12 may be either of two-stroke or four-stroke cycle type, and the generator 15 may be either of single phase or AC type.

1. A charging device for an internal combustion engine, a battery for supplying electric power to a component driven by said internal combustion engine, a generator driven said internal combustion engine to generate electric power to be supplied as charging current to said battery, and a charge controller for controlling the value of the charging current according to the operating state of said internal combustion engine, said charge controller controlling the supply to said battery, said charging current corresponding to part, after a certain phase, of positive voltage waveform of the generated electric power and to adjusting the phase in response to the speed of said internal combustion engine.

2. A charging device as set forth in claim 1, wherein there is an electric starting motor for starting of the internal combustion engine and the charge controller reduces the supply of generated electrical power during operation of said electric starting motor.

3. A charging device as set forth in claim 1, wherein the amount of charging current supplied to the battery is varied in the same direction as the engine speed changes.

4. A charging device as set forth in claim 1, wherein the internal combustion engine drives a vehicle.

5. A charging device as set forth in claim 4 wherein the vehicle has electrical devices powered by the battery.

6. A charging device as set forth in claim 5 wherein there is an electric starting motor for starting of the internal combustion engine and the charge controller reduces the supply of generated electrical power during operation of said electric starting motor.

7. A charging device as set forth in claim 6 wherein the amount of charging current supplied to the battery is varied in the same direction as the engine speed changes.
